(19) United States
(12) Patent Application Publication
(10) Pub. No.: US 2011/0033637 A1
(43) Pub. Date: Feb. 10, 2011

(54) Method and apparatus for printing on a surface

(75) Inventors: Jerry Kim, San Diego, CA (US); Christopher Russo, San Diego, CA (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignee: SONY CORPORATION

(21) Appl. No.: 12/660,332

(22) Filed: Feb. 24, 2010

Related U.S. Application Data
(60) Provisional application No. 61/232,634, filed on Aug. 10, 2009.

(51) Int. Cl. B05D 3/06

(52) U.S. Cl. 427/559

(57) ABSTRACT

Embodiments of the present invention generally include a method and apparatus for performing printing onto a product. Specifically, embodiments of the invention comprise a printing apparatus and a method for printing on a product surface. Further, the printing apparatus comprises a laser etch system, and a printer. A masking film is applied to the product to be printed upon. The laser etch system creates an etch pattern through the masking film and into the product being printed upon. An ink pattern is applied to the etch pattern. The masking film is then removed to revealed the print pattern on the product.

### CROSS-REFERENCE TO RELATED APPLICATIONS

This application claims benefit of U.S. provisional patent application Ser. No. 61/232,634, filed Aug. 10, 2009, which is herein incorporated by reference.

### BACKGROUND

1. Field of the Invention

Embodiments of the present invention generally relate to direct printing on a surface and, more particularly, to a method and apparatus for performing direct printing on plastic surfaces using Ultraviolet (UV) curable ink.

2. Description of the Related Art

Today, plastics are among the most widely used materials for manufacture of various articles. The plastic products are usually protected by several coatings including chrome and Ultraviolet (UV) coated paper stocks, vinyls, glass polycarbonates, polypropylenes, polyethylenes, polyester, polyacrylate and/or the like. Such coatings ensure the plastic is protected from the environment, especially, from UV sunlight. Without such protective coatings, plastic products would quickly degrade, losing color and become brittle. Plastic products are printed upon for identification, aesthetic purposes and/or the like. Among various ink options, UV curable inks are being increasingly used. However, direct printing onto plastic surfaces and/or the protective coating using the UV curable inks presents several challenges.

Typically, applying UV curable ink presents a challenge in that the print patterns fail to adhere to the surface of most plastics and are especially difficult to adhere to protective coatings. Further, once printed, such print patterns exhibit, in general, poor durability and short term adherence to surfaces, i.e., the printing scratches easily. Such issues with printing UV curable inks have been addressed by applying a liquid solvent to the surface of the coating layer to increase adhesion between the coating and the ink, i.e., the solvent roughens the surface of the coating layer. However, applying liquid solvent for increasing the adhesion involves a cumbersome printing process and also dulls the surface where the solvent is applied. Further, even with the application of liquid solvents, although improved over printing without a solvent, the print patterns still show poor durability.

Accordingly, there exists a need for a method and apparatus to provide improved printing on various surfaces.

### SUMMARY OF THE INVENTION

According to an embodiment of the present invention, a method and apparatus for printing on a surface of plastic products is provided. A masking film is applied to a product surface. An etch pattern conforming to a desired print design is created through the masking film and in the product surface. The etch pattern is created, for example, by a laser etch system. At least one UV curable ink is applied onto the etch pattern, such that the ink pattern is wider than the etch pattern. The UV curable ink is then cured. The masking film is removed to reveal a print pattern conforming to the etch pattern on the product.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a system for applying a print in accordance with the present invention;

FIG. 2A to FIG. 2F a cross sectional view of a portion of a plastic product at various stages of a printing process in accordance with one or more embodiments of the present invention;

FIG. 3A illustrates a top view of an ink pattern upon an etch pattern on a plastic product in accordance with one or more embodiments of the present invention;

FIG. 3B illustrates a top view of the etch pattern having a revealed print pattern on the plastic product in accordance with one or more embodiments of the present invention; and

FIG. 4 is a flow chart illustrating a method for applying a print in accordance with one embodiment of the present invention.

### DETAILED DESCRIPTION

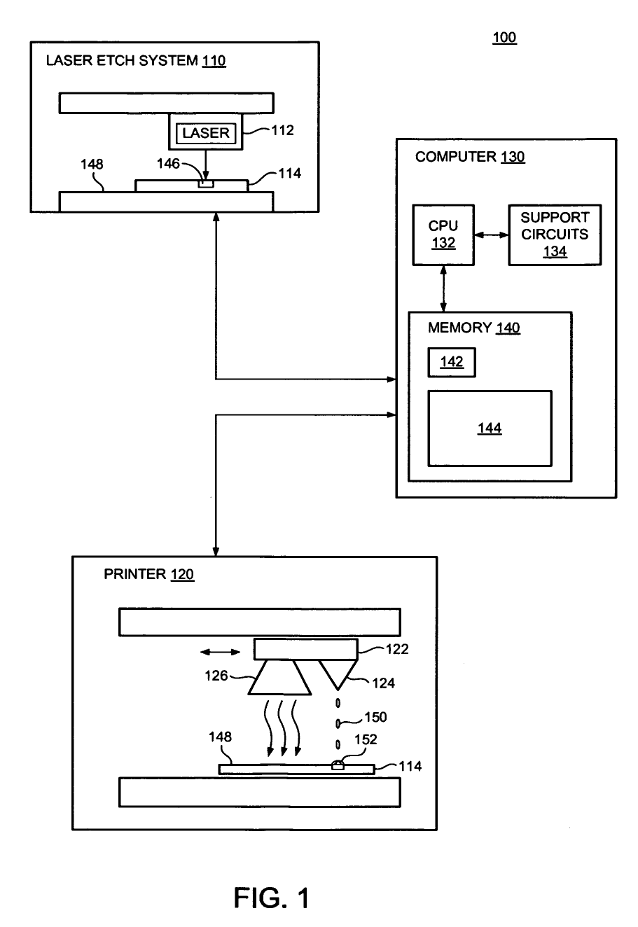

FIG. 1 illustrates a system 100 for printing on surfaces in accordance with an embodiment of the present invention. The system 100 comprises a laser etch system 110, a printer 120 and a computer 130 (e.g., a print controller). The laser etch system 110 is configured to create an etch pattern 146 on a surface 148 of a product 114. The printer 120 is configured to print on the product 114, for example, using UV curable ink 150. The laser etch system 110 and the printer 120 are coupled to the computer 130. The computer 130 is configured to operate the laser etch system 110 and the printer 120 for applying a print pattern 152 to the surface 148 of the product 114.

According to various embodiments, the product 114 comprises materials such as, plastics, plastic-metal composites, glass, vinyls and various other such materials. Generally, any material that can be laser etched can be printed upon using embodiments of the present invention. In one example, such materials are used in the manufacturing of various electronic items (e.g. cell phones, computers, laptops, and the like), components for automobiles, aircraft, ships, machinery, packaging and other articles of manufacture. Accordingly, those skilled in the art will appreciate that the various embodiments discussed may be applied in a wide variety of printing applications.

The laser etch system 110 comprises a laser head 112 and other support circuit and electronics (not shown). The laser head 112 is capable of forming an etch pattern 146 on the surface 148 of the product 114. The etch pattern 146 is a pattern formed by removal of material from the surface 148 of the product 114.

The printer 120 comprises a print head 122. The print head 122 includes an ink nozzle 124 and an ultraviolet (UV) lamp 126. The ink nozzle 124 is configured to apply an ink pattern 152 on the product 114. For example, the ink pattern 152 is applied to substantially overlap with the etch pattern 146 created by the laser etch system 110. According to an embodiment, the ink pattern is made using a UV curable ink 150. The UV lamp 126 is configured to cure the UV curable ink 150 when applied to the surface 148 of the product 114. The print head 122 is configured to move such that the print head 122 applies the ink and thereafter, the UV lamp 126 cures the applied ink.

The computer 130 comprises a Central Processing Unit (CPU) 132, for example, a microprocessor or a microcontroller as generally known in the art, support circuits 134, and a memory 140. The support circuits are well known circuits that facilitate operation of the CPU. Such support circuits may comprise, but are not limited to, clock circuits, cache, power supplies, input/output circuits, buses, network interference cards and/or the like. The memory may comprise random access memory, read only memory, disk drives, optical drives, and combinations thereof. The memory 140 comprises an operating system 142 and printing control software 144. The printing control software 144, when executed by CPU 132, causes the computer 130 to instruct the laser etch system 110 and the printer 120 in accordance with a method embodiment of the present invention. The computer 130 is operatively coupled to the laser etch system 110 and the printer 120, and further, the computer 130 controls the laser etch system 110 and the printer 120 to apply a print on to the surface of the product 114. Those skilled in the art will appreciate that the functionality of the computer 130 may also be delivered, at least partially, by one or more application specific integrated circuit chips, and all such variations are contemplated herein. Although the laser etch system 110, printer 120 and computer 130 are shown as separate components, it is contemplated that, in one embodiment of the invention, these elements could be combined to form an integrated printing system.

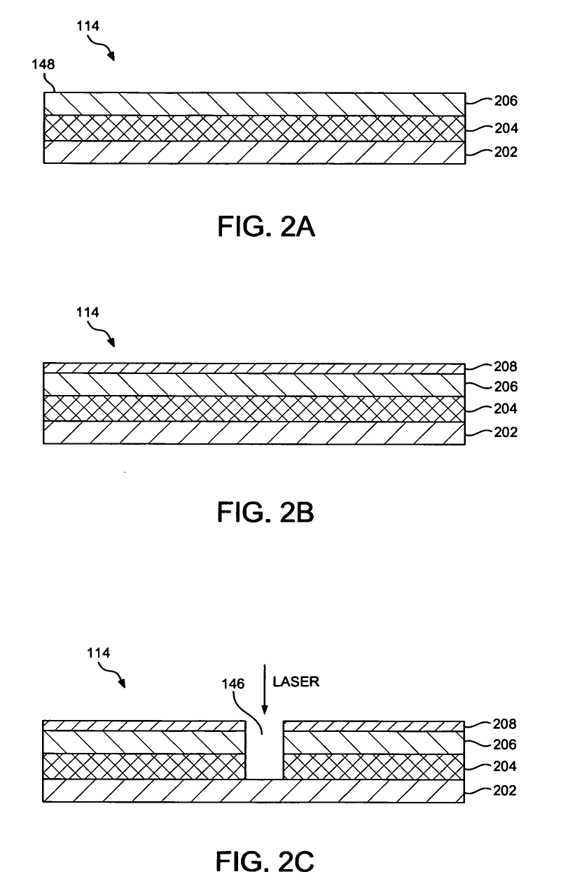

FIG. 2A to FIG. 2F illustrate various stages of a portion of a plastic product 114 being printed upon, according to an embodiment of the present invention. The printing is accomplished, for example, using the system 100 of FIG. 1. As illustrated in FIG. 2A, in one embodiment, the product 114 comprises plastic layer 202, (e.g., a polycarbonate acrylonitrile-butadiene styrene (PC ABS)), a color-based coat layer 204, and a clear coat layer 206 (e.g., UV protective layer). In another embodiment, the product surface may be the plastic layer 202, i.e., the layer 202 is not covered with a coating. As described herein, the product surface is intended to include the plastic layer with or without one or more protective or coloring coating layers.

As shown in FIG. 2B, a masking film 208 is applied to the clear coat layer 206 of the product 114. In alternative embodiments, the masking film 208 is applied on to the color-based coat layer 204 directly, and in such embodiments the clear coat layer 206 may be absent, or be built into (or fused with) the color-based coat layer 204, or be applied after the printing, on the product, is accomplished. In one embodiment, the masking film is a polyester tape having a low-tack adhesive such as acrylic-based adhesive. Because, in one embodiment, a laser is applied to the masking film to etch the underlying plastic materials, the masking film has a high service temperature, e.g., about 350° F. (177° C.). Also, to promote laser etching, the masking film is relatively thin, e.g., about 1.3 mils (0.03 mm). One example of a commercially available film that can function as the masking film is available from 3M Corporation as Polyester Protective Tape 1675.

FIG. 2C illustrates the creation of an etch pattern 146 in the surface on to the product 114. The etch pattern 146 is created, for example, using the laser etch system 110 of FIG. 1. The etch pattern 146 is formed through the masking film 208, the clear coat layer 206 (if present), and the color-based coat layer 204. The depth of the etch pattern 146 may be varied as desired, and may extend up to (and including a portion of) the plastic layer 202.

FIG. 2D illustrates the application and UV curing of a base ink 212 to the etch pattern 146. The base ink 212 may be a white ink or any other suitable color to provide a neutral base for the desired print color. The base ink 212 is applied in a base ink pattern, using, for example, the printer 120 of FIG. 1. The base ink 212 may have a wider application pattern than the etch pattern 146 i.e., the base ink 212 is applied within the etched pattern 210 as well as on to the masking film 208 as a base ink over spray 214. Further, the base ink 212 is applied such that only a partial depth of the etch pattern 210 is filled, leaving space for additional ink. The base ink 212 (and the base ink over spray 214) is then cured, for example, using the ultraviolet lamp 126 (shown in FIG. 1).

Next, as illustrated by FIG. 2E, a color ink 216 is applied and cured over the base ink 212 within the etch pattern. The color ink 216 may have an application pattern width (color ink pattern) that is wider than the etch pattern 210 i.e., the color ink 216 is applied to the etch pattern 210 and onto the masking film 208, creating a color ink over spray 218 on the masking film 208. The color ink 216 (including the color ink over spray 218) is cured using ultraviolet (UV) radiation. An ink pattern comprising the color ink 216 (and the color ink over spray 218), the base ink 212 (and the base ink over spray 214) is formed on the product 114 and the masking film 208. In the next step, as illustrated by FIG. 2F, the masking film 208 is removed along with the base ink over spray 214 and the color ink over spray 218. The color ink 216 and the base ink 212 are retained in the etch pattern 210. The removal of the masking film 208 (along with the base ink over spray 214 and the color ink over spray 218) reveals a clean print pattern on the product 200.

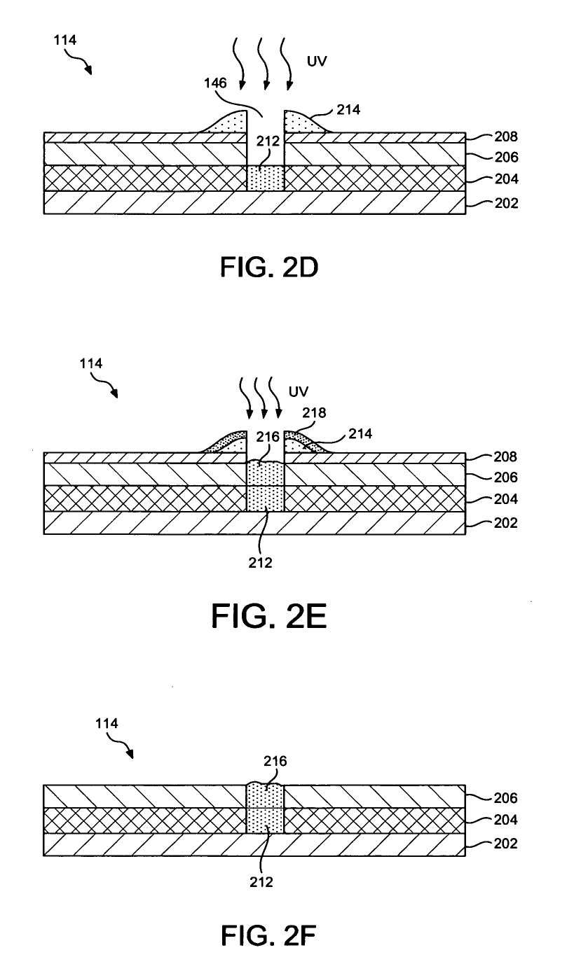

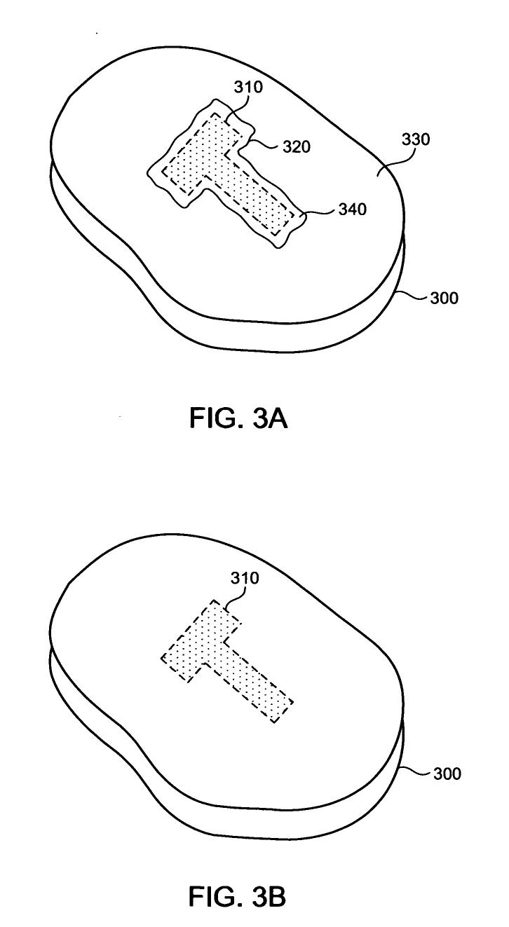

FIG. 3A and FIG. 3B illustrate removal of a masking film from a product 300 printed upon, for example, in a similar manner as illustrated by FIGS. 2A to 2F. As illustrated in FIG. 3A, the product 300 has a masking film 330 and an etch pattern 310. Ink(s) (including base and color inks) are applied to the product 300 in an ink pattern 320 over the masking film 330. The ink has been applied to fill the etch pattern 310 and form an over spray region 340.

FIG. 3B illustrates the product 300 after the masking film 330 has been removed along with the ink over spray region 340 of the ink pattern 320, thereby revealing the ink cleanly deposited ink within the etch pattern 310.

Accordingly, an accurate and clean print is accomplished. The ink is deposited into the etch pattern, as discussed, and accordingly the durability of the print is greatly enhanced. Accordingly, various embodiments, as disclosed, advantageously provide durable prints on surfaces using UV curable inks. Those skilled in the art will appreciate that while the embodiments of FIGS. 2A-2F and FIGS. 3A-3B have been discussed with reference to plastic products having PC ABS base layer, a color-coated layer and a clear coated layer, the techniques discussed herein are equally extensible for printing on other materials, having one or more constituent layers, and all such obvious variations are included within the scope and spirit of the present invention. Furthermore, the forgoing embodiments included printing a base ink followed by a color ink. In other embodiments, a single color ink could be applied in a single step.

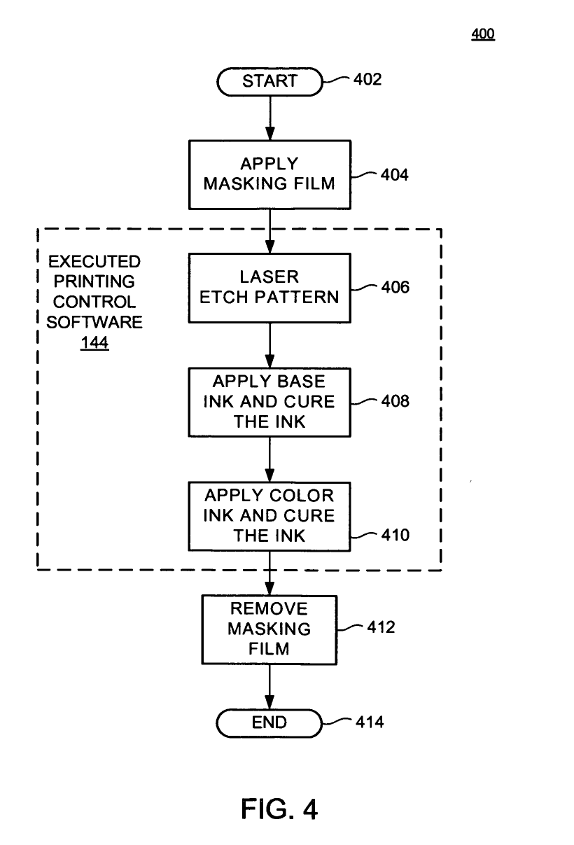

FIG. 4 is a flowchart illustrating a method 400 for printing, according to an embodiment of the present invention. According to an embodiment, the method 400 is implemented in part, by the printing control software 144 when executed by the CPU 232 of FIG. 1.

The method 400 starts at step 402 and proceeds to step 404 at which a masking film is applied onto a product. The product is then positioned in the laser etch system. At step 406, the printing control software 144 is executed to cause method 400 to create a laser etch pattern in the product surface and the masking film. After etching, the product may be moved to the printer. At step 408, a base ink is applied to the etch pattern and cured with ultraviolet (UV) radiation. In one embodiment, the base ink is applied such that at least a partial volume of the etch pattern is left unfilled. The base ink is applied to create an over spray with respect to the etch pattern. At step 410, a color ink is applied to the etch pattern of the product and cured with UV radiation. The color ink is applied over the base ink. The color ink is applied to create an over spray with respect to the etch pattern. The portion of the method 400 performed through execution of the printing control software ends at step 408. At step 412, the masking film is removed from the product, along with the base ink over spray and the color ink over spray, revealing a clean print on the product. The method 400 ends at step 414.

As discussed, the direct printing in accordance with the various embodiments of the system and method disclosed herein provide increased durability of the print patterns. Further, direct printing techniques, as discussed, increase adherence of the print patterns to the product without requiring additional materials, such as solvents. Prints as enabled by various embodiments of the present invention are highly suitable for high gloss finished surfaces of various products. Furthermore, the various embodiments provide increased scratch and abrasion resistance (e.g., tested by applying scratching stimuli moving 100 times back and forth across the print), and improved alcohol resistance (e.g., tested by rubbing the print with alcohol 15 times back and forth), among several other advantages. While, the present invention is described in connection with the preferred embodiments of the various figures. It is to be understood that other similar embodiments may be used. Modifications/additions may be made to the described embodiments for performing the same function of the present invention without deviating therefore. Therefore, the present invention should not be limited to any single embodiment, but rather construed in breadth and scope in accordance with the recitation of the appended claims.

1. A method of printing on a product, the method comprising:
etching an etch pattern in a masking film and into a surface of the product, where the masking film is adhered to the surface of the product; and
applying at least one ink in an ink pattern on the etch pattern, wherein the ink pattern is slightly wider than the etch pattern (310) to form an over spray region on the masking film.

2. The method of claim 1, further comprising exposing the at least one ink to ultraviolet (UV) radiation, to cure the at least one ink.

3. The method of claim 2, wherein applying the at least one ink comprises applying a base ink, and wherein the method further comprises curing the base ink.

4. The method of claim 3, wherein applying at least one ink further comprises applying a color ink over the base ink, and wherein the method further comprises curing the color ink.

5. The method of claim 1, further comprising removing the masking film to reveal a print pattern on the product, the print pattern contained substantially within the etch pattern.

6. The method of claim 1 wherein the masking film comprises polyester.

7. The method of claim 1, wherein the etch pattern is created using a laser.

8. The method of claim 1, wherein the surface of the product comprises a protective coating layer.

9. The method of claim 1, wherein the surface of the product comprises a layer including a color coat layer and a clear coat layer.

10. The method of claim 1, wherein the product further comprises a polycarbonate acrylontitrile-butadiene styrene (PC ABS) layer.

11. The method of claim 7, wherein the etch pattern has a depth penetrating through the protective coating layer.

12. The method of claim 11, wherein the etch pattern has a depth penetrating at least partially to the PC ABS layer.

13. The method of claim 1 wherein the masking film comprises an acrylic adhesive.

14. The method of claim 1 wherein the masking film has a service temperature of about 350 degrees Fahrenheit (177 degrees Celsius).

15. Apparatus for printing on a product comprising: a laser etch system for etching an etch pattern in a masking film and into a surface of a product, where the masking film is adhered to the surface of the product; and
a printer for applying at least one ink in an ink pattern onto the etch pattern, where in the ink pattern is slightly wider than the etch pattern to form an over spray region on the masking film.

16. The apparatus of claim 15 wherein the masking film comprises polyester.

17. The apparatus of claim 15 wherein the masking film comprises an acrylic adhesive.

18. The apparatus of claim 15 wherein the masking film has a service temperature of about 350 degrees Fahrenheit (177 degrees Celsius).

19. The apparatus of claim 15 wherein the surface of the product comprises a protective coating layer.

20. The apparatus of claim 19 wherein the laser etch pattern penetrates the masking film, the protective coating layer and contacts a plastic material of the product.
